(19) United States
(12) Patent Application Publication
(10) Pub. No.: US 2007/0178258 A1
(43) Pub. Date: Aug. 2, 2007

(54) Hydraulic Anti-Vibration Support And Method For Manufacturing It

(76) Inventors: Pascal Petit, Beaugency (FR); Franck Rabineau, Thiville (FR); Herve Visage, Chateaudun (FR); Gilles Chenais, Marboue (FR)

Correspondence Address: ST. ONGE STEWARD JOHNSTON & REENS, LLC, 986 BEDFORD STREET, STAMFORD, CT, 06905-5619, US

(21) Appl. No.: 11/669,629

(22) Filed: Jan. 31, 2007

(30) Foreign Application Priority Data
Feb. 1, 2006 (FR) 0600933

(51) Int. Cl. B32B 1/08; B29C 65/00

(52) U.S. Cl. 428/34.1; 264/248

(57) ABSTRACT

Hydraulic anti-vibration support comprising first and second rigid frames interconnected by an elastomeric body which partially delimits an operating chamber filled with liquid, the second frame being fixed to a flexible elastomeric wall which partially delimits a compensation chamber communicating with the operating chamber via a restricted passage, the operating chamber and compensation chamber being separated from each other by a rigid partition fixed to the second frame. The second frame comprises first and second parts made from plastics material which are assembled to each other by rotary friction welding, and which are fixed, respectively, to the elastomeric body and to the flexible elastomeric wall.

### CROSS-REFERENCE TO RELATED APPLICATIONS

The present application claims priority from French patent application 0600933 filed on Feb. 1, 2006, the content of which is incorporated herein by reference.

### FIELD OF THE INVENTION

The present invention relates to hydraulic anti-vibration supports and methods for manufacturing them.

More specifically, the invention relates to a hydraulic anti-vibration support comprising first and second rigid frames interconnected by an elastomeric body which partially delimits an operating chamber filled with liquid, the second frame being fixed to a flexible elastomeric wall which partially delimits a compensation chamber communicating with the operating chamber via a restricted passage, the operating and compensation chambers being separated from each other by a rigid partition fixed to the second frame.

### BACKGROUND OF THE INVENTION

EP-A-0 346 227 describes an anti-vibration support of this kind, which is entirely satisfactory. In this anti-vibration support, the first and second frames are metallic and the hydraulic chambers are sealed by cramping metal parts on the second frame.

### SUMMARY OF THE INVENTION

The object of the present invention is to provide further improvements to the anti-vibration supports of this type, specifically in order to improve the performance with respect to at least one of the following aspects:

improvement of sealing,

reduction of the production cost,

reduction of the weight,

easier adhesion of the elastomers,

simplification of the manufacturing process,

limitation of the overall dimensions of the anti-vibration support,

limitation or elimination of parasitic noise generated by the anti-vibration support.

For this purpose, the invention proposes a method of manufacturing a hydraulic anti-vibration support comprising first and second rigid frames interconnected by an elastomeric body which partially delimits an operating chamber filled with liquid, the second frame being fixed to a flexible elastomeric wall which partially delimits a compensation chamber communicating with the operating chamber via a restricted passage, the operating and compensation chambers being separated from each other by a rigid partition fixed to the second frame, the second frame comprising first and second parts made from plastics material which are assembled to each other by welding and which are fixed, respectively, to the elastomeric body and to the flexible elastomeric wall, the first and second parts made from plastics material being in contact with each other by means of a welding area forming a symmetrical surface of revolution about a central axis, this method comprising a welding step in which the first and second parts made from plastics material are welded together to form the second frame, thus sealing the operating chamber and the compensation chamber.

Because of these arrangements, it is unnecessary to cramp metal parts to seal the hydraulic chambers, and the reliability of this seal is thereby improved.

Moreover, the method of manufacturing the anti-vibration support is simplified (a friction welding device is more easily incorporated into a production line for elastomeric components than a stamping press or an aluminium injection press), and its production cost is generally reduced (because of the simplification of the manufacturing process and also the lower cost of plastics material as compared with metal).

The overall dimensions and weight of the anti-vibration support are also generally reduced as compared with prior art anti-vibration supports.

Additionally, if the elastomers and plastics materials used are compatible with each other (particularly if the elastomers or at least one of the elastomers used are thermoplastic elastomers), the adhesion of the elastomers to the second frame is facilitated.

Finally, since the second frame is made from plastics material, its dynamic vibration modes are considerably damped, in such a way as to limit or eliminate the parasitic noise which can normally be generated by metal frames. This is because metal frames have dynamic vibration modes with little damping, and these vibration modes are also difficult to control, since they vary from one anti-vibration support to another depending on the constraints introduced into the materials by assembly.

In different embodiments of the method according to the invention, one and/or the other of the following arrangements can also be used if required:

each of the first and second parts made from plastics material comprises at least first and second circular shoulders in the welding area, the first shoulders of the first and second parts made from plastics material facing each other and lying parallel to the central axis, and the second shoulders of the first and second parts made from plastics material facing each other and lying parallel to the central axis, the said first and second shoulders being positioned so that only the first shoulders are in contact with each other when the first and second parts made from plastics material are pressed against each other at the start of the welding step, and the first shoulders melt during the welding step, thus allowing the first and second parts made from plastics material to move towards each other until the second shoulders also come into contact with each other and melt in their turn;

the first and second parts made from plastics material are rotated with respect to each other during the welding step, at a speed ranging from 600 to 800 r.p.m.

The invention also proposes a support made by a method as defined above, comprising first and second rigid frames interconnected by an elastomeric body which partially delimits an operating chamber filled with liquid, the second frame being fixed to a flexible elastomeric wall which partially delimits a compensation chamber communicating with the operating chamber via a restricted passage, the operating and compensation chambers being separated from each other by a rigid partition fixed to the second frame, the second frame comprising first and second parts made from plastics material which are assembled to each other by welding and which are fixed, respectively, to the elastomeric body and to the flexible elastomeric wall, the first and second parts made from plastics material being in contact with each other by means of a welding area forming a symmetrical surface of revolution about a central axis.

In different embodiments of the anti-vibration support according to the invention, any one and/or other of the following arrangements can also be used if required:

the first and second parts made from plastics material are in contact with each other by means of a welding area forming a symmetrical surface of revolution, in which the said first and second parts made from plastics material are welded together;

the partition is fixed in rotation with respect to the second frame;

the flexible elastomeric wall is made from an elastomeric thermoplastic and is overmoulded onto the second part made from plastics material;

the first frame is metallic and is mostly overmoulded with the elastomeric body;

the second frame is fixed to a movement limiting member with a U-shaped cross section, which covers the first frame and the elastomeric body, the elastomeric body having bosses adapted to bear on the limiting member;

the limiting member is made from plastics material;

the limiting member has, between two opposing lateral edges:
an upper web covering the first frame,
two lateral wings, each extending on a different side of the web to a free end,
a link interconnecting the free ends of the two wings at one of the lateral edges, and the said second frame is fitted into a groove in the general shape of a U, formed in the free ends of the wings and in the link;

the second frame has a filling aperture which connects the exterior to an inner volume comprising the operating chamber, the compensation chamber and the restricted passage, the said filling aperture being blocked;

the first and second parts made from plastics material are made from glass-fibre reinforced polyamide;

the glass fibres represent not more than 35% by weight of the plastics material.

### BRIEF DESCRIPTION OF THE DRAWINGS

Other characteristics and advantages of the invention will be made clear by the following description of one of its embodiments, provided by way of example and without restrictive intent, with reference to the attached drawing.

FIG. 1 is a perspective view of an anti-vibration support according to one embodiment of the invention;

FIG. 2 is a perspective view of the anti-vibration support of FIG. 1, viewed in another direction;

FIG. 3 is a frontal view of the anti-vibration support of FIGS. 1 and 2;

FIG. 4 and FIG. 5 are views in vertical section of the anti-vibration support of FIGS. 1 to 3, FIG. 4 showing a section taken along the line IV-IV of FIG. 5 and FIG. 5 showing a section taken along the line V-V of FIG. 4,

FIG. 6 is a sectional detail view taken along the line 6-6 in FIG. 5; and

FIG. 7 is a sectional view similar to FIG. 4, showing the anti-vibration device before the assembly of the two parts made from plastics material forming its second frame.

### DETAILED DESCRIPTION OF THE INVENTION

In the different figures, the same references denote identical or similar elements.

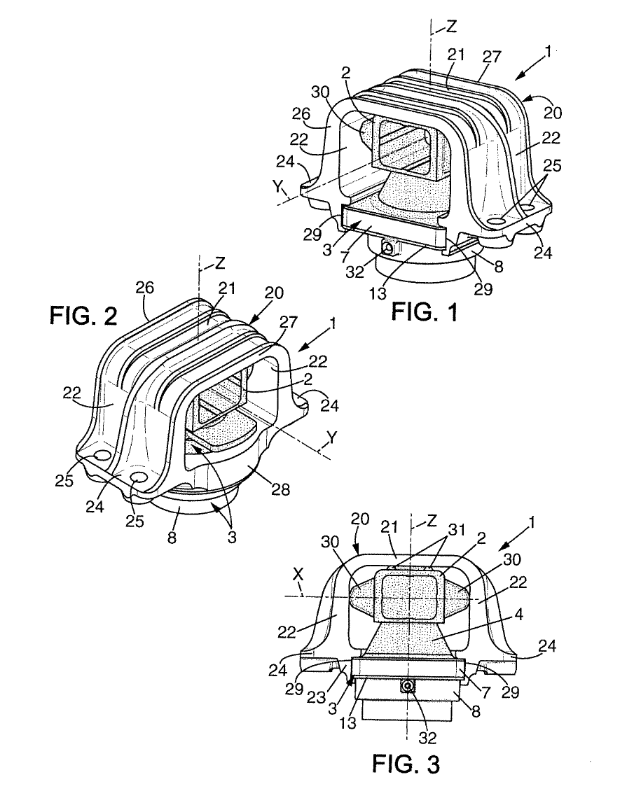

FIGS. 1 to 5 show a hydraulic anti-vibration support 1 which is intended, for example, to connect a power unit of a motor vehicle to the body of the vehicle. The anti-vibration support 1 has first and second rigid frames 2, 3 which are interconnected by an elastomeric body 4.

In the example considered here, the elastomeric body has a substantially truncated conical shape and extends, along a generally vertical central axis Z, between:

an annular base 5 which is overmoulded and bonded to part of the second frame 3,

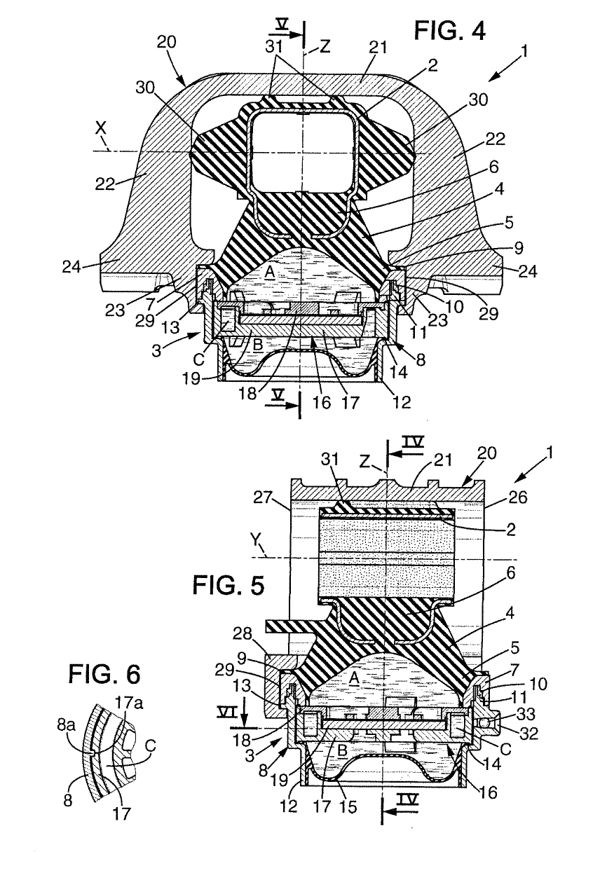

and a top 6 which is overmoulded on and bonded to the first frame 2 (see FIGS. 4 and 5).

The first frame 2, which can be intended, for example, to be connected to the power unit of the vehicle, can, in particular, take the form of a rolled piece of sheet, forming an open sleeve along a transverse axis Y perpendicular to the axis Z. The said first frame is mostly (and preferably entirely) overmoulded with the elastomeric body, so as to damp all the parasitic vibrations due to the dynamic vibration modes of the said piece of rolled sheet.

The second frame 3 comprises first and second parts made from plastics material 7, 8, which are assembled to each other by welding. The two parts 7, 8 are made from the same plastics material, or from plastics materials which are different but can be welded together.

For example, the parts 7, 8 can both be made from polyamide 6-6 with a glass fibre filler, the glass fibre filler accounting for less than 35% by weight (about 30%, for example).

In this case, the first part made from plastics material 7 takes the form of an annular plate extending perpendicularly to the axis Z, with an inner circular profile centred on the axis Z, on which the base 5 of the elastomeric body is overmoulded and bonded, and a substantially rectangular outer profile. The first part made from plastics material 7 also has an upper face which can, for example, be covered with a layer of elastomers made in one piece with the base 5 of the elastomeric body and a lower face provided with a circular groove 10 centred on the axis Z and opening downwards (see FIGS. 4, 5 and 7).

The second part made from plastics material 8 has a tubular shape with a circular cross section centred on the axis Z and extending along the said axis Z between a first end 11 fitted and welded into the groove 10 and a free second end 12.

Additionally, in the vicinity of the first end 11, the second part made from plastics material 8 has an outer flange 13 having the same shape as the outer profile of the first part made from plastics material 7 and positioned in alignment with the said outer profile. The second part made from plastics material 8 also has a restriction which forms an upwardly facing shoulder 14 between the outer flange 13 and the second end 12.

A flexible elastomeric wall 15, in the form of a membrane, is also overmoulded on the inside of the second part made from plastics material 8, preferably between the shoulder 14 and the second end 12 of the said second part made from plastics material. This flexible wall 15 can advantageously be made from elastomeric thermoplastic, for example Vegaprene®, marketed by the Hutchinson Group. In this case, the flexible elastomeric wall 15 adheres to the second part made from plastics material 8 simply by overmoulding, without the need to add adhesive between the elastomer and the second part made from plastics material. Advantageously, the elastomer of the flexible wall 15 lines the shoulder 14 in the direction of the elastomeric body 4.

As shown in FIGS. 4, 5 and 7, the anti-vibration support 1 also has a rigid partition 16 which, in the illustrated example, comprises two superimposed grids of plastics material 17, 18, which enclose, with a degree of clearance, a central isolating valve 19, and which delimit between them an annular restricted passage C which surrounds the isolating valve 19.

The elastomeric body 4, the second frame 3 and the flexible elastomeric wall 15 thus delimit a sealed interior volume which is filled with liquid and which is divided by the partition 16 into an operating chamber A next to the elastomeric body 4 and a compensation chamber B next to the flexible elastomeric wall 15. The operating chamber A communicates with the compensation chamber B via the restricted passage C.

Additionally, as shown in FIGS. 1 to 3, the second frame 3 is fixed to a movement limiting member 20 made from plastics material, formed for example from polyamide 6-6 with a glass fibre filler, or other material.

The movement limiter 20 covers the first frame 2 and the elastomeric body 4, and it has a generally U-shaped cross section, with:

a substantially horizontal upper web 21, which covers the first frame 2,

and two lateral wings 22, each extending downwards on a different side of the upper web 21 to a free end 23. Each lateral wing 22 also has, in the vicinity of the free end 23, an outer flange 24 provided with fixing holes 25 for fixing the limiting member 1, and thus the second frame 3, to the body of the vehicle.

The limiting member extends along the aforementioned axis Y between lateral edges 26, 27. At the lateral edge 27, the free ends 23 of the two lateral wings of the limiting member are interconnected by a link 28. The link 28 and the free ends 23 of the two lateral wings delimit between them a generally U-shaped channel 29 in which the first part made from plastics material 7 and the outer flange 13 of the second part made from plastics material are tightly fitted. The tight assembly in the channel 29 is facilitated by the layer of elastomer 9 which covers the upper face of the first part made from plastics material 7 and which is compressed vertically between the upper face of the first part made from plastics material 7 and the opposing face of the channel 29.

The limiting member 20 enables the movements of the first frame 2 to be limited by means of the bosses 30, 31 of the elastomeric body which are formed on the said first frame. The bosses 30 are adapted to bear on the lateral wings 22 of the limiting member in a transverse direction X perpendicular to the aforementioned directions Y, Z, and the bosses 31 are adapted to bear on the web 21 of the limiting member in the direction of the axis Z.

Finally, the anti-vibration support can if necessary have a filling aperture 32 formed in the second part made from plastics material 8 of the second frame. The filling aperture 32 allows the inner volume A, B, C of the anti-vibration support to communicate with the outside. This filling aperture 32 is blocked, for example by a ball 33 (see FIG. 5), force-fitted into the said aperture, or by any other blocking means, after the inner volume of the anti-vibration support has been evacuated and filled with liquid.

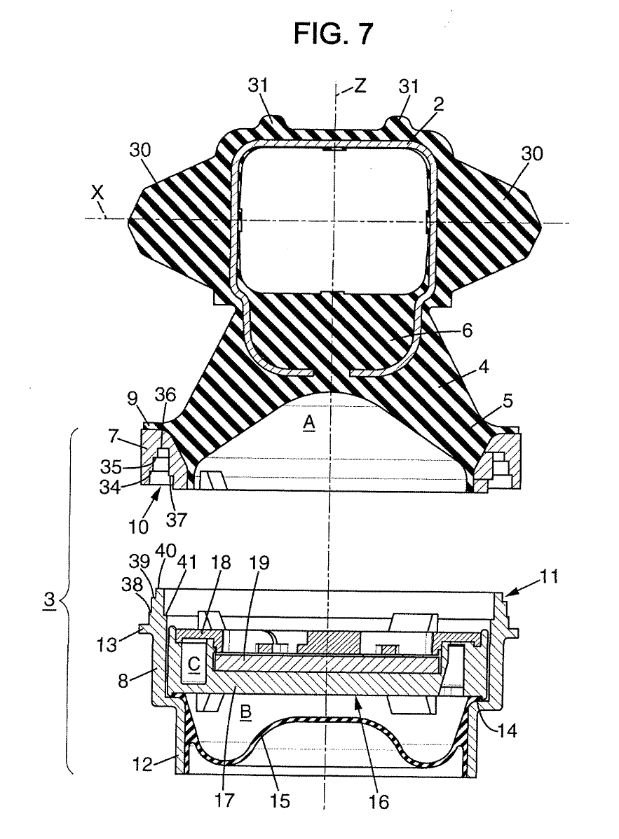

As shown in FIG. 7, in the manufacture of the anti-vibration support, the following two sub-assemblies are initially made:

a first sub-assembly comprising the elastomeric body 4 overmoulded on the first frame 2 and the first part made from plastics material 7,

and a second sub-assembly comprising the second part made from plastics material 8 in which the flexible elastomeric wall 15 is overmoulded and in which the rigid partition 16 is fitted.

Advantageously, the rigid partition 16 is fitted into the second part made from plastics material 8 without the possibility of relative rotation between the two parts about the axis Z. For example, as shown in FIG. 6, the second part made from plastics material 8 can be provided locally with a vertical rib which penetrates into a corresponding channel 17a formed on the outside of the grid 17 of the rigid partition.

After the construction of these two sub-assemblies, the first and second part made from plastics material 7, 8 are fitted and welded together, by any known welding method, for example ultrasonic welding, hot blade welding, laser welding or friction welding. In the example considered here, it is possible to use friction welding for example, by rotating the second part made from plastics material 8 and the rigid partition 16 about the axis Z, while keeping the first part made from plastics material 7 fixed, and while engaging the first end 11 of the second part made from plastics material in the circular channel 10 of the first part made from plastics material with a certain degree of pressure. The rotation speed of the second part made from plastics material 8 can be, for example, about 600 to 800 revolutions per minute, for the usual size of anti-vibration supports.

Advantageously, the circular channel 10 of the first part made from plastics material and the first end 11 of the second part made from plastics material have stepped shapes to facilitate the frictional melting of the plastics material.

In particular, in the example considered, the channel 10 has, from the outside towards the inside, a shoulder 34, followed by a deeper shoulder 35 and by a groove 36 which is also deeper, the groove 36 itself being followed, towards the inside, by a shoulder 37 which is less deep than the shoulder 34.

The first end 11 of the second part made from plastics material has, from the outside towards the inside:

a shoulder 38,

a shoulder 39 positioned at a higher level than the shoulder 38,

a shoulder 40 formed by the end face of the first end 11,

and a shoulder 41 at a lower level than the shoulder 38.

During the friction welding process, the shoulder 40 initially comes into contact with the shoulder 35, which causes these two shoulders to melt and enables the first and second parts made from plastics material 7 and 8 to be brought towards each other. The shoulder 39 then comes into contact with the shoulder 34, causing these two shoulders to melt, until the first end 11 of the second part made from plastics material is completely fitted into the channel 10 of the first part made from plastics material. At the end of the welding process, the rotation of the second part made from plastics material 8 is stopped in an indexed position in which the flange 13 forms a geometric match with the outer profile of the first part made from plastics material 7.

After the welding step, the inner volume of the anti-vibration support is filled by means of the aforementioned filling aperture 32.

The anti-vibration support described above operates in a conventional way, as follows:

when the first and second frames 2, 3 are subjected to relative vibratory movements of relatively high amplitude (more than a millimetre, for example) and relatively low frequency (less than 20 Hz, for example) along the axis Z, these movements cause liquid to be transferred between the operating and compensation chambers A, B, via the restricted passage C, with damping,

and when the two frames 2, 3 are subjected to relative vibratory movements of relatively low amplitude (less than a millimetre, for example) and relatively high frequency (more than 20 Hz, for example), these movements essentially result in low-amplitude movements of the isolating valve 19 between the two grids 17, 18, thus enabling the vibrations to be filtered and preventing their transmission from one frame to the other.

What is claimed is:

1. Method of manufacturing a hydraulic anti-vibration support comprising first and second rigid frames interconnected by an elastomeric body which partially delimits an operating chamber filled with liquid, the second frame being fixed to a flexible elastomeric wall which partially delimits a compensation chamber communicating with the operating chamber via a restricted passage, the operating chamber and compensation chamber being separated from each other by a rigid partition fixed to the second frame, the second frame comprising first and second parts made from plastics material which are assembled to each other by welding and which are fixed, respectively, to the elastomeric body and to the flexible elastomeric wall,
the first and second parts made from plastics material being in contact with each other in a welding area forming a symmetrical surface of revolution about a central axis,
this method comprising a welding step, in which the first and second parts made from plastics material are welded together to form the second frame, thus sealing the operating chamber and the compensation chamber,
and, during the welding step, the first and second parts made from plastics material are rotated with respect to each other about the central axis while the said first and second parts made from plastics material are pressed against each other in the said welding area, thus producing a friction weld.

2. Method according to claim 1, in which each of the first and second parts made from plastics material comprises at least first and second circular shoulders in the welding area, the first shoulders of the first and second parts made from plastics material facing each other and lying parallel to the central axis, and the second shoulders of the first and second parts made from plastics material facing each other and lying parallel to the central axis, the said first and second shoulders being positioned so that only the first shoulders are in contact with each other when the first and second parts made from plastics material are pressed against each other at the start of the welding step, and the first shoulders melt during the welding step, thus allowing the first and second parts made from plastics material to move towards each other until the second shoulders also come into contact with each other and melt in their turn.

3. Method according to claim 1, in which the first and second parts made from plastics material are rotated with respect to each other during the welding step, at a speed ranging from 600 to 800 r.p.m.

4. Anti-vibration support produced by a method according to claim 1, comprising first and second rigid frames interconnected by an elastomeric body which partially delimits an operating chamber filled with liquid, the second frame being fixed to a flexible elastomeric wall which partially delimits a compensation chamber communicating with the operating chamber via a restricted passage, the operating chamber and compensation chamber being separated from each other by a rigid partition fixed to the second frame, the second frame comprising first and second parts made from plastics material which are assembled to each other by welding and which are fixed, respectively, to the elastomeric body and to the flexible elastomeric wall, the first and second parts made from plastics material being in contact with each other in a welding area forming a symmetrical surface of revolution about a central axis.

5. Anti-vibration support according to claim 4, in which the partition is fixed in rotation with respect to the second frame.

6. Anti-vibration support according to claim 4, in which the flexible elastomeric wall is made from elastomeric thermoplastic and is overmoulded on the second part made from plastics material.

7. Anti-vibration support according to claim 4, in which the first frame is metallic and is mostly overmoulded with the elastomeric body.

8. Anti-vibration support according to claim 4, in which the second frame is fixed to a movement limiting member with a U-shaped cross section, which covers the first frame and the elastomeric body, the elastomeric body having bosses adapted to bear on the limiting member.

9. Anti-vibration support according to claim 4, in which the limiting member is made from plastics material.

10. Anti-vibration support according to claim 4, in which the limiting member includes, between two opposing lateral edges:
an upper web covering the first frame,
two lateral wings, each extending on a different side of the web to a free end,
a link interconnecting the free ends of the two wings at one of the lateral edges,
and the said second frame is fitted into a channel in the general shape of a U, formed in the free ends of the wings and in the link.

11. Anti-vibration support according to claim 4, in which the second frame has a filling aperture which connects the exterior to an inner volume comprising the operating chamber, the compensation chamber and the restricted passage, the said filling aperture being blocked.

12. Anti-vibration support according to claim 4, in which the first and second parts made from plastics material are made from glass fibre reinforced polyamide.

13. Anti-vibration support according to claim 12, in which the glass fibres represent not more than 35% by weight of the plastics material.
